(19) United States
(12) Patent Application Publication
(10) Pub. No.: US 2024/0135916 A1
(43) Pub. Date: Apr. 25, 2024

(54) NON-TRANSITORY COMPUTER-READABLE RECORDING MEDIUM, SOUND PROCESSING METHOD, AND SOUND PROCESSING SYSTEM

(71) Applicant: YAMAHA CORPORATION, Hamamatsu-shi (JP)

(72) Inventor: Makoto TACHIBANA, Hamamatsu-shi (JP)

(21) Appl. No.: 18/483,570

(22) Filed: Oct. 10, 2023

(30) Foreign Application Priority Data
Oct. 12, 2022 (JP) 2022-163721

(51) Int. Cl. G10L 13/033; G10L 13/047

(52) U.S. Cl. CPC G10L 13/0335; G10L 13/047

(57) ABSTRACT

A non-transitory computer-readable recording medium storing a program that, when executed by a computer system, causes the computer system to perform a method including altering a first portion of first time-series data in accordance with an instruction from a user. The first time-series data indicates a time series of a sound characteristic corresponding to a first pronunciation style of a target sound to be synthesized. The method also includes generating second time-series data when a second pronunciation style different from the first pronunciation style is specified for the target sound. The second time-series data indicates a sound characteristic with the alteration made to the first portion in accordance with the instruction from the user, and indicating a sound characteristic with a second portion other than the first portion corresponding to the second pronunciation style.

### CROSS-REFERENCE TO RELATED APPLICATIONS

The present application claims priority under 35 U.S.C. § 119 to Japanese Patent Application No. 2022-163721, filed Oct. 12, 2022. The contents of this application are incorporated herein by reference in their entirety.

### FIELD

The present disclosure relates to a non-transitory computer-readable recording medium, a sound processing method, and a sound processing system.

### BACKGROUND ART

Sound synthesizing techniques for synthesizing a desired sound such as a singing sound (hereinafter referred to as “target sound”), for example, have been proposed. JP 6747489 B2 discloses one example of the technique for synthesizing a target sound pronounced as it should be in a style that a user has selected from a plurality of different pronunciation styles.

In editing a target sound, various items such as the pronunciation style or synthesis conditions (e.g., sound pitch of the target sound) are changed as needed in accordance with instructions from the user. In one conceivable circumstance, for example, the user may instruct changes to be made to the sound characteristics of the target sound while switching from one pronunciation style to another on a trial-and-error basis. One issue under such circumstances is that the workload for the user in giving instructions is high when the system requires the user to instruct the alterations to be made to the sound characteristics of the target sound every time the pronunciation style is changed. The present disclosure has been made in view of the above-described and other problems, and has an object to allow generation of a target sound reflecting instructions from a user while alleviating the workload of the user in giving instructions.

### SUMMARY

One aspect of the present disclosure is a non-transitory computer-readable recording medium storing a program that, when executed by a computer system, causes the computer system to perform a method including altering a first portion of first time-series data in accordance with an instruction from a user, the first time-series data indicating a time series of a sound characteristic corresponding to a first pronunciation style of a target sound to be synthesized. The method also includes generating second time-series data when a second pronunciation style different from the first pronunciation style is specified for the target sound, the second time-series data indicating a sound characteristic with the alteration made to the first portion in accordance with the instruction from the user, and indicating a sound characteristic with a second portion other than the first portion corresponding to the second pronunciation style.

Another aspect of the present disclosure is a computer system-implemented method of sound processing. The method includes altering a first portion of first time-series data in accordance with an instruction from a user, the first time-series data indicating a time series of a sound characteristic corresponding to a first pronunciation style of a target sound to be synthesized. The method also includes generating second time-series data when a second pronunciation style different from the first pronunciation style is specified for the target sound, the second time-series data indicating a sound characteristic with the alteration made to the first portion in accordance with the instruction from the user, and indicating a sound characteristic with a second portion other than the first portion corresponding to the second pronunciation style.

Another aspect of the present disclosure is a sound processing system. The system includes a sound processing circuit configured to generate time-series data indicating a time series of a sound characteristic of a target sound to be synthesized. The system also includes a characteristics edit circuit configured to change the time-series data in accordance with an instruction from a user. The sound processing circuit is configured to generate first time-series data indicating a time series of a sound characteristic of the target sound corresponding to a first pronunciation style. The characteristics edit circuit is configured to alter a first portion of the first time-series data in accordance with an instruction from the user. The sound processing circuit is further configured to generate second time-series data when a second pronunciation style different from the first pronunciation style is specified for the target sound. The second time-series data indicates a sound characteristic with the alteration made to the first portion in accordance with the instruction from the user. The second time-series data also indicates a sound characteristic with a second portion other than the first portion corresponding to the second pronunciation style.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the following figures.

FIG. 1 is a block diagram of an example configuration of a sound processing system according to a first embodiment.

FIG. 2 is a block diagram of an example functional configuration of the sound processing system.

FIG. 3 is a schematic illustration of an edit screen.

FIG. 4 is a schematic illustration of an operation region of the edit screen.

FIG. 5 is a schematic illustration of the edit screen.

FIG. 6 is a partial schematic illustration of an edit region.

FIG. 7 is a flowchart of voice synthesis processing.

FIG. 8 illustrates how phoneme string data is updated in the first embodiment.

FIG. 9 is a flowchart of processing that generates second phoneme string data.

FIG. 10 shows specific examples of first phoneme string data and second phoneme string data.

FIG. 11 is a schematic illustration of an edit screen in a second embodiment.

FIG. 12 illustrates how pitch data is updated in a third embodiment.

FIG. 13 is a flowchart of processing that generates second pitch data.

FIG. 14 illustrates how a sound signal is updated in a fourth embodiment.

FIG. 15 is a flowchart of processing that generates a second sound signal.

FIG. 16 is a schematic illustration of an edit screen in a modification of one embodiment.

FIG. 17 is a flowchart of processing that generates a second sound signal in the modification.

FIG. 18 is a schematic illustration of edited data in the modification.

### DESCRIPTION OF THE EMBODIMENTS

The present development is applicable to a non-transitory computer-readable recording medium, a sound processing method, and a sound processing system.

### First Embodiment

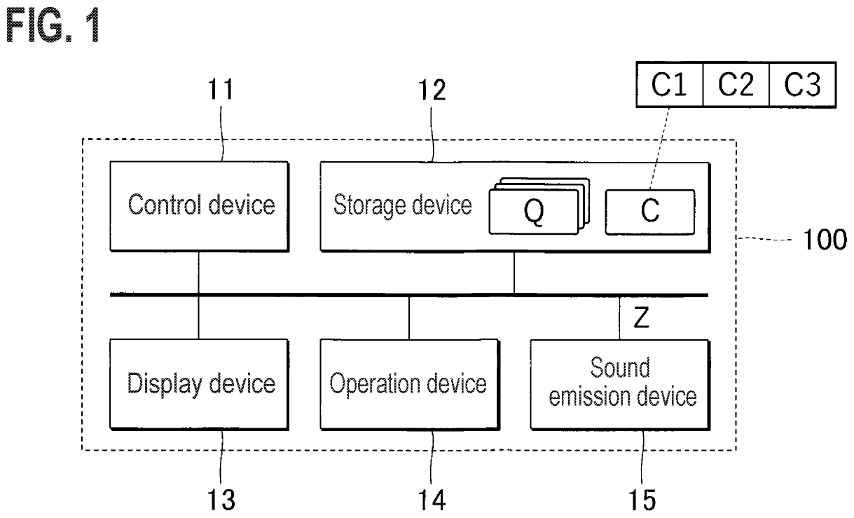

FIG. 1 is a block diagram of an example configuration of a sound processing system 100 according to a first embodiment. The sound processing system 100 is a computer system for synthesizing a sound as desired by a user (hereinafter referred to as “target sound”). The target sound is a sound that is to be synthesized by the sound processing system 100. The target sound according to the first embodiment is a singing sound of a virtual singer singing a specific musical piece (hereinafter referred to as “target musical piece”) in a specific pronunciation style, pronounced as it should be. The sound processing system 100 generates a sound signal Z that represents a waveform of the target sound.

The pronunciation style represents the nature of the target sound that affects its auditory impression such as the tone or rhythm. A pronunciation style manifests as characteristic tendencies in pronunciation such as for example peculiar ways of singing and other expressive techniques. For example, when the starting points, or ending points, of discrete phonemes of lyrics tend to be advanced or retarded relative to the starting points or ending points of respective musical notes, this is considered a peculiar way of singing.

The sound processing system 100 includes a control device 11, a storage device 12, a display device 13, an operation device 14, and a sound emission device 15. The sound processing system 100 is implemented in the form of an information device such as a smartphone, tablet terminal, and a personal computer, for example. It is to be noted that the sound processing system 100 may be a single device or a combination of a plurality of devices separate from each other.

The control device 11 is a single processor or a plurality of processors that control various elements of the sound processing system 100. Specifically, the control device 11 includes one or more of the processors including, for example, CPU (Central Processing Unit), GPU (Graphics Processing Unit), SPU (Sound Processing Unit), DSP (Digital Signal Processor), FPGA (Field Programmable Gate Array), and ASIC (Application Specific Integrated Circuit).

The storage device 12 is a single memory or a plurality of memories that store programs executed by the control device 11 and various pieces of data used by the control device 11. Examples of the storage device 12 include a known recording medium such as a semiconductor recording medium and a magnetic recording medium, and a combination of a plurality of kinds of recording mediums. Other examples of the storage device 12 include a portable recording medium attachable and detachable to and from the sound processing system 100; and a cloud storage or a similar recording medium accessible by the control device 11 via a communication network.

The storage device 12 according to the first embodiment stores a plurality of pieces of style data Q corresponding to different pronunciation styles. The style data Q of a pronunciation style represents sound characteristics of a singing sound pronounced in this pronunciation style. The style data Q according to the first embodiment is an embedding vector in a multidimensional virtual space. The virtual space is a continuous space, where the location of each pronunciation style is determined in accordance with the sound characteristics of the singing sound. The more similar the sound characteristics of singing sounds, the smaller the distance between the vectors representing the respective pronunciation styles. As is understood from the above, the virtual space is described as a space that indicates a relationship between pronunciation styles about the characteristics of singing sounds. Style data Q is also described as a code string for identifying a pronunciation style.

The storage device 12 also stores control data C for target musical pieces. The control data C specifies synthesis conditions of a target sound. More specifically, the control data C is musical piece data that specifies a sound pitch C1, a pronunciation period C2, and a pronounced character C3 for each of a plurality of musical notes of a target musical piece. The sound pitch C1 is a number assigned to one of a plurality of scale notes. The pronunciation period C2 is specified, for example, by the time at a starting point and the duration of a musical note. Alternatively, the pronunciation period C2 may be specified by the time at a starting point and the time at an ending point of a musical note, for example. The pronounced character C3 is a grapheme used for writing lyrics of a target musical piece. One or more pronounced letters C3 forming a single syllable are set to each musical note of the target musical piece. A music file compliant with MIDI (Musical Instrument Digital Interface) standard, for example, is used as the control data C. The control data C is provided from a distribution device (not shown), for example, via a communication network to the sound processing system 100.

The display device 13 displays images under the control of the control device 11. The display device 13 is, for example, a display panel, such as a liquid-crystal display panel or an organic EL (Electroluminescence) panel. The operation device 14 is an input device that receives instructions from a user. The operation device 14 is, for example, an operator operated by the user, or a touch panel that detects touch inputs made by the user. It is to be noted that a display device 13 or an operation device 14 that are separate from the sound processing system 100 may be connected to the sound processing system 100 via a wire or wirelessly.

The sound emission device 15 reproduces a sound under the control of the control device 11. Specifically, the sound emission device 15 reproduces a target sound represented by a sound signal Z. A speaker or a pair of headphones, for example, may be used as the sound emission device 15. The sound signal Z is converted from a digital signal to an analogue signal by a D/A converter and amplified by an amplifier. The D/A converter and the amplifier, however, are not illustrated for the sake of simplicity. It is to be noted that a sound emission device 15 that is separate from the sound processing system 100 may be connected to the sound processing system 100 via a wire or wirelessly.

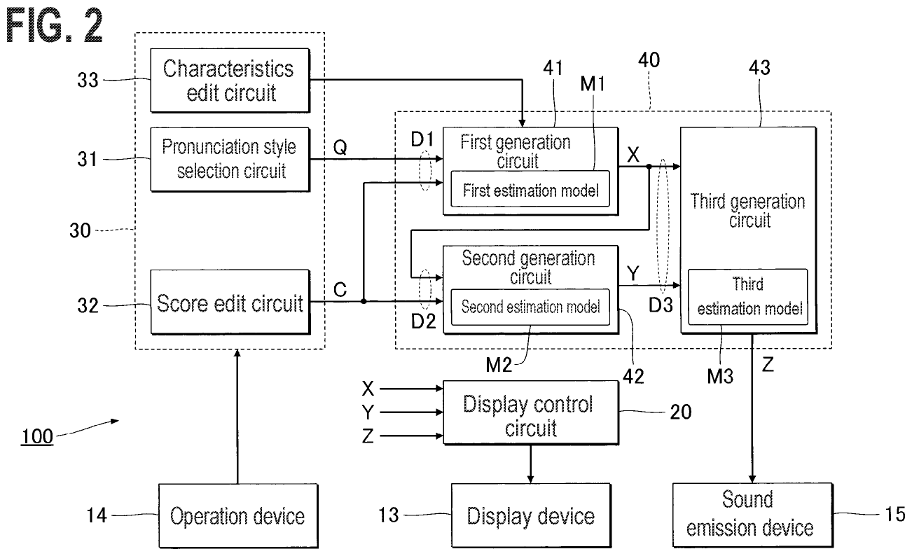

FIG. 2 is a block diagram of an example functional configuration of the sound processing system 100. The control device 11 executes the program stored in the storage device 12 to implement a plurality of functions, including a display control circuit 42, an edit control circuit 30, and a sound processing circuit 40, to generate a sound signal Z of a target sound. The program executed by the control device 11 is a software voice synthesizer and includes an editor for editing the target sound.

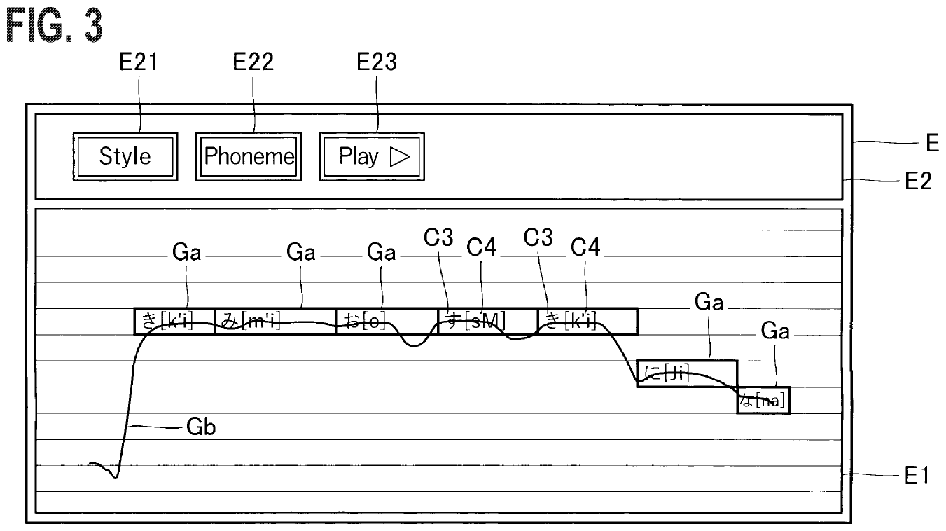

The display control circuit 20 displays images on the display device 13. The display control circuit 20 according to the first embodiment displays an image E that allows editing of a target musical piece (hereinafter referred to as “edit screen”) on the display device 13. FIG. 3 is a schematic illustration of an edit screen E. The edit screen E includes an edit region E1 and an operation region E2.

The edit region E1 is a region where a target musical piece is displayed. In the edit region E1 is a coordinate plane defined by time axis (horizontal axis) and pitch axis (vertical axis). The edit region E1 displays musical note images Ga and a pitch transition Gb. The pitch transition Gb shows a time series of the pitch of the target sound.

A musical note image Ga is displayed for each musical note specified by the control data C. The position and display length of a musical note image Ga in the direction of time axis are set in accordance with the pronunciation period C2 of the musical note. The position of the musical note image Ga in the direction of pitch axis is set in accordance with the sound pitch C1 of the musical note. A pronounced letter C3 and a phoneme symbol C4 are added to the musical note image Ga of each musical note. The pronounced letter C3 is a letter specified by the control data C. The phoneme symbol C4 is a symbol of one or more phonemes corresponding to the pronounced letter C3. In other words, the target sound according to the first embodiment is a voice including a plurality of phonemes on the time axis. Phonemes are one example of the “sound unit”.

The user can instruct how to edit the target musical piece by operating the operation device 14. For example, the user instructs various changes to be made to a musical note by an operation performed to the edit region E1. Examples of the editing tasks instructed by the user include adding or deleting a musical note, or moving a musical note in the direction of time axis or pitch axis; extending or shortening a pronunciation period C2; and specifying or changing the pronounced letter C3 of each musical note.

The operation region E2 is a region that receives instructions from the user. The operation region E2 displays operation images E21, E22, and E23.

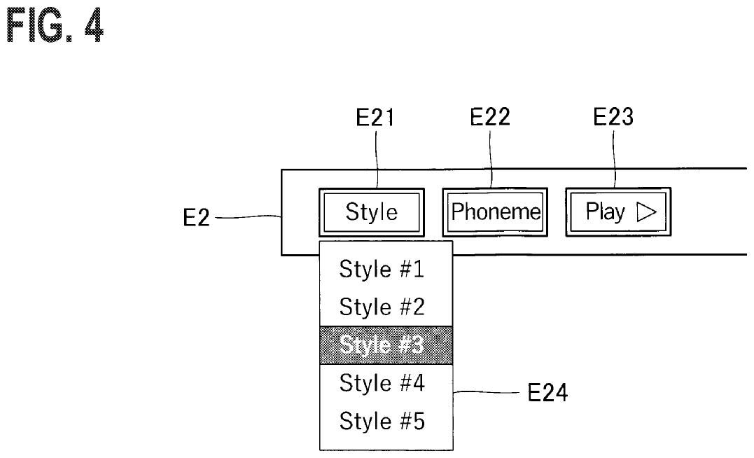

The operation image E21 is an image for the user to select a pronunciation style. An operation made to the operation image E21 causes the display control circuit 20 to display a list E24 of a plurality of pronunciation styles (Style #1, Style #2, . . . ) on the display device 13 as exemplified in FIG. 4. The user can select a desired pronunciation style (hereinafter referred to as “selected style”) from the plurality of pronunciation styles by operating the operation device 14.

The operation image E23 in FIG. 3 is an image for instructing reproduction of the target sound. An operation made to the operation image E23 causes a sound signal Z to be supplied to the sound emission device 15 and the target sound to be reproduced. The user can edit the target sound by making operations to the edit screen E while listening to the target sound being reproduced by an operation of the operation image E23.

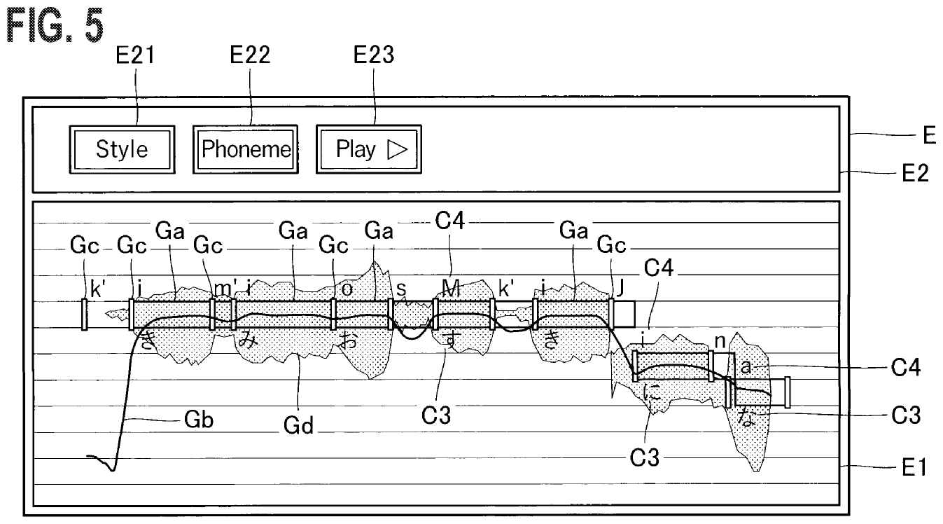

The operation image E22 is an image for the user to edit the position of an end point (starting point or ending point) of each phoneme in the target sound. An operation made to the operation image E22 causes the display control circuit 20 to display end point images Gc and a signal waveform Gd together with the musical note images Ga and the pitch transition Gb on the display device 13 as exemplified in FIG. 5. In other words, operating the operation image E22 switches between display and hide of the end point images Gc and signal waveform Gd. The signal waveform Gd is a waveform of the sound signal Z of the target sound.

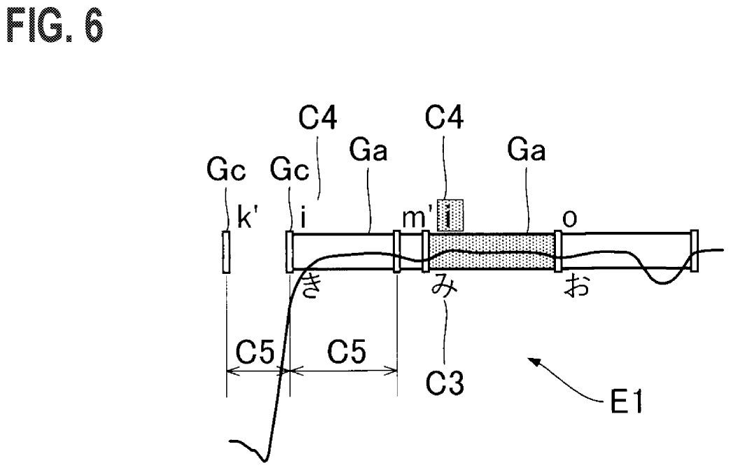

FIG. 6 is a partial schematic illustration of the edit region E1 with an operation being carried out to the operation image E22. The end point image Gc is an image representing an end point (starting point or ending point) of each of the phonemes making up the target sound. The end point images Gc are placed at the positions of end points of the individual phonemes on the time axis. The distance between two end point images Gc adjacent to each other on the time axis signifies the period of duration of one phoneme (hereinafter referred to as “phoneme period C5”). The user can shift a desired end point image Gc in the direction of time axis by operating the operation device 14. In other words, the user can instruct an end point (starting point or ending point) of each phoneme to be shifted. A shift of an end point image Gc signifies a change in length of time of a phoneme period C5.

With an operation being performed to the operation image E22, a pronounced letter C3 is displayed below each musical note image Ga, and a phoneme symbol C4 is displayed above the musical note image Ga. The user can select one phoneme period C5 by operating the operation device 14 as required. For example, the mouse pointer is positioned over a phoneme period C5 to set it to a selected state. The display control circuit 20 highlights the phoneme symbol C4 and phoneme period C5 of the phoneme in the selected state. In FIG. 6, a phoneme symbol /i/and the phoneme period C5 corresponding to this phoneme symbol C4 are highlighted. In other words, the phoneme symbol C4 and phoneme period C5 of the phoneme in the selected state are displayed in a different style from that of the phoneme symbol C4 and phoneme period C5 of the phoneme in a non-selected state. For example, the phoneme symbol C4 of the phoneme in the selected state is displayed with hatching, and the display color of the phoneme period C5 is changed. Therefore, the user can visually and intuitively grasp the relationship between the phoneme symbol C4 and the phoneme period C5 of a desired phoneme.

The edit control circuit 30 in FIG. 2 edits the target sound in accordance with the instructions from the user. The edit control circuit 30 according to the first embodiment includes a pronunciation style selection circuit 31, a score edit circuit 32, and a characteristics edit circuit 33.

The pronunciation style selection circuit 31 receives an instruction from the user to select one of the plurality of pronunciation styles (selected style). The pronunciation style selection circuit 31 obtains one of the plurality of pieces of style data Q that corresponds to the selected style from the storage device 12.

The score edit circuit 32 updates the control data C in accordance with the instructions from the user given to the edit region E1. In other words, instructions regarding changes to be made to the musical notes (addition, deletion, shifting, extension and shortening, etc.) are reflected in the control data C. The characteristics edit circuit 33 changes the end point of one or more phonemes (phoneme periods C5) of the target sound in accordance with instructions given to the end point images Gc from the user. The processing performed by the characteristics edit circuit 33 will be described later in more detail.

The sound processing circuit 40 generates time-series data that specifies a time series of a sound characteristic of the target sound. Specifically, the sound processing circuit 40 generates phoneme string data X, pitch data Y, and a sound signal Z as time-series data. The phoneme string data X is time-series data indicating the positions of end points (starting points or ending points) of respective phonemes making up the target sound. In other words, the phoneme string data X specifies the positions (e.g., time) of end points of respective phonemes on the time axis as a sound characteristic of the target sound. The pitch data Y is time-series data representing a pitch transition Gb of the target sound. In other words, the pitch data Y specifies the pitch of the target sound as a sound characteristic. The sound signal Z is time-series data representing a waveform of the target sound. In other words, the sound signal Z specifies the amplitude and tone of the target sound as sound characteristics.

The display control circuit 20 displays the time-series data generated by the sound processing circuit 40 on the display device 13. For example, the display control circuit 20 displays each end point image Gc in the edit screen E, using the phoneme string data X. In other words, the display control circuit 20 displays an end point image Gc at the position of each end point specified by the phoneme string data X for each phoneme. When the user gives an instruction to change the position of an end point of a desired phoneme, the display control circuit 20 changes the position of the end point image Gc corresponding to this phoneme in accordance with the instruction. The display control circuit 20 also displays a pitch transition Gb indicated by the pitch data Y in the edit region E1. The display control circuit 20 also displays a signal waveform Gd indicated by the sound signal Z in the edit region E1.

The sound processing circuit 40 according to the first embodiment includes a first generation circuit 41, a second generation circuit 42, and a third generation circuit 43. Various elements of the sound processing circuit 40 are now described in more detail.

### First Generation Circuit 41

The first generation circuit 41 generates the phoneme string data X. Specifically, the first generation circuit 41 generates the phoneme string data X by processing first input data D1. The first input data D1 includes the control data C of a target musical piece and the style data Q of a selected style. For example, the first generation circuit 41 processes the first input data D1 for each unit period on the time axis to generate a portion corresponding to the unit period of the phoneme string data X. The first input data D1 includes a portion corresponding to the unit period of the control data C and the style data Q of a selected style. The first generation circuit 41 couples together the portions of the phoneme string data X over a plurality of unit periods to generate the phoneme string data X.

A first estimation model M1 is used for the generation of phoneme string data X by the first generation circuit 41. The first estimation model M1 is a statistical model that has learned the relationship between the first input data D1 and the phoneme string data X by machine learning. The first estimation model M1 is configured by a deep neural network, for example. Any desired type of deep neural network such as a recurrent neural network or a convolutional neural network may be used as the first estimation model M1. The first estimation model M1 may be configured by a combination of a plurality of types of deep neural networks. An additional element such as a long short-term memory (LSTM) or Attention may be mounted to the first estimation model M1.

The first estimation model M1 is implemented by a combination of a program that causes the control device 11 to execute an arithmetic operation for generating phoneme string data X from the first input data D1, and a plurality of variables (specifically, weighted values and biases) to be applied to this arithmetic operation. The plurality of variables that define the first estimation model M1 are preset by machine learning and stored in the storage device 12.

A plurality of pieces of first training data are used for the machine learning of the first estimation model M1. Each piece of first training data includes the first input data D1 for the learning and phoneme string data X for the learning. The control data C of the first input data D1 specifies a synthesis condition, and the style data Q of the first input data D1 specifies a pronunciation style. The phoneme string data X of each piece of first training data is answer data that specifies the correct positions of end points of respective phonemes when sung under the specified synthesis condition and in the specified pronunciation style.

In the machine learning of the first estimation model M1, the plurality of variables of the first estimation model M1 are repeatedly updated such as to reduce the error between phoneme string data X the first estimation model M1 temporarily outputs in accordance with the first input data D1 of each piece of first training data, and the phoneme string data X of this first training data. Therefore, the first estimation model M1 outputs statistically reasonable phoneme string data X in response to unknown first input data D1 based on a potential relationship between the first input data D1 and the phoneme string data X in each of the plurality of pieces of first training data. Specifically, the phoneme string data X specifies the correct positions of end points of respective phonemes of the target musical piece specified by the control data C when sung in the selected style. In other words, the phoneme string data X is dependent on the selected style. Therefore, when the selected style is changed, the positions of end points of respective phonemes specified by the phoneme string data X change, too.

As described above, according to the first embodiment, the phoneme string data X is generated by the first estimation model M1 through processing of the first input data D1 that includes the control data C specifying a synthesis condition of the target sound, and the style data Q indicating a pronunciation style. Therefore, phoneme string data X that is statistically reasonable can be generated based on a relationship that exists between the first input data D1 and the phoneme string data X in each of the plurality of pieces of first training data used for the machine learning.

The phoneme string data X generated by the first generation circuit 41 is used for displaying end point images Gc for respective phonemes in the edit screen E of the display device 13. The user can select one of the plurality of end point images Gc corresponding to a desired phoneme, and shift the end point image Gc in the selected state on the time axis by operating the operation device 14. An instruction to shift an end point image Gc corresponds to an instruction to shift an end point of a phoneme on the time axis. In other words, the user can instruct an end point of a desired phoneme to be shifted.

The characteristics edit circuit 33 changes the end point of one or more of the plurality of phonemes of the target sound in accordance with an instruction from the user. In other words, the characteristics edit circuit 33 alters the phoneme string data X by changing the position of the end point of the phoneme selected by the user in accordance with the instruction from the user. Specifically, the characteristics edit circuit 33 updates the phoneme string data X to indicate the positions of end points of respective phonemes that have been altered in accordance with instructions from the user. Among the end points of a plurality of phonemes specified by the phoneme string data X, the end points whose positions have been changed by the user are one example of the “first portion”.

Second Generation Circuit 42

The second generation circuit 42 generates pitch data Y. Specifically, the second generation circuit 42 generates the pitch data Y by processing second input data D2. The second input data D2 includes the control data C of a target musical piece and the phoneme string data X generated by the first generation circuit 41. In the case where the characteristics edit circuit 33 has altered the phoneme string data X, the phoneme string data X included in the second input data D2 is the one after the alteration. Therefore, the generated pitch data Y reflects the instructions from the user regarding the changes in the positions of respective phoneme end points.

For example, the second generation circuit 42 processes the second input data D2 for each unit period on the time axis to generate a portion corresponding to the unit period of the pitch data Y. The second input data D2 includes a portion corresponding to the unit period of the control data C and a portion corresponding to the unit period of the phoneme string data X. The second generation circuit 42 couples together the portions of the pitch data Y over a plurality of unit periods to generate the pitch data Y.

A second estimation model M2 is used for the generation of pitch data Y by the second generation circuit 42. The second estimation model M2 is a statistical model that has learned the relationship between the second input data D2 and the pitch data Y by machine learning. The second estimation model M2 is configured by a deep neural network, for example. Any desired type of deep neural network such as a recurrent neural network or a convolutional neural network may be used as the second estimation model M2. The second estimation model M2 may be configured by a combination of a plurality of types of deep neural networks. An additional element such as a long short-term memory or Attention may be mounted to the second estimation model M2.

The second estimation model M2 is implemented by a combination of a program that causes the control device 11 to execute an arithmetic operation for generating pitch data Y from the second input data D2, and a plurality of variables (specifically, weighted values and biases) to be applied to this arithmetic operation. The plurality of variables that define the second estimation model M2 are preset by machine learning and stored in the storage device 12.

A plurality of pieces of second training data are used for the machine learning of the second estimation model M2. Each piece of second training data includes the second input data D2 for the learning and pitch data Y for the learning. The control data C specifies a musical piece, and the phoneme string data X specifies phoneme periods C5. The pitch data Y of each piece of second training data is answer data that specifies the correct pitch transition Gb of the musical piece when sung with the specified phoneme periods C5.

In the machine learning of the second estimation model M2, the plurality of variables of the second estimation model M2 are repeatedly updated such as to reduce the error between pitch data Y the second estimation model M2 temporarily outputs in accordance with the second input data D2 of each piece of second training data, and the pitch data Y of this second training data. Therefore, the second estimation model M2 outputs statistically reasonable pitch data Y in response to unknown second input data D2 based on a potential relationship between the second input data D2 and the pitch data Y in each of the plurality of pieces of second training data. Specifically, the pitch data Y indicates the correct pitch transition of the target musical piece specified by the control data C when sung with the specified phoneme periods C5 specified by the phoneme string data X. As mentioned above, the phoneme string data X is dependent on the selected style, and therefore the pitch data Y is indirectly dependent, via the phoneme string data X, on the selected style. Therefore, when the selected style is changed, the pitch transition Gb specified by the pitch data Y changes, too.

As described above, according to the first embodiment, the pitch data Y is generated by the second estimation model M2 through processing of the second input data D2 that includes the control data C and phoneme string data X. Therefore, pitch data Y that is statistically reasonable can be generated based on a relationship that exists between the second input data D2 and the pitch data Y in each of the plurality of pieces of second training data used for the machine learning.

### Third Generation Circuit 43

The third generation circuit 43 generates a sound signal Z. Specifically, the third generation circuit 43 generates the sound signal Z by processing third input data D3. The third input data D3 includes the phoneme string data X generated by the first generation circuit 41, and the pitch data Y generated by the second generation circuit 42. As mentioned above, the pitch data Y reflects the instructions from the user regarding the changes in the positions of respective phoneme end points. Therefore, the sound signal Z also reflects the instructions from the user regarding the changes in the positions of respective phoneme end points.

For example, the third generation circuit 43 processes the third input data D3 for each unit period on the time axis to generate a portion corresponding to the unit period of the sound signal Z. The third input data D3 includes a portion corresponding to the unit period of the phoneme string data X and a portion corresponding to the unit period of the pitch data Y. The third generation circuit 43 couples together the portions of the sound signal Z over a plurality of unit periods to generate the sound signal Z.

A third estimation model M3 is used for the generation of the sound signal Z by the third generation circuit 43. The third estimation model M3 is a statistical model that has learned the relationship between the third input data D3 and the sound signal Z by machine learning. The third estimation model M3 is configured by a deep neural network, for example. Any desired type of deep neural network such as a recurrent neural network or a convolutional neural network may be used as the third estimation model M3. The third estimation model M3 may be configured by a combination of a plurality of types of deep neural networks. An additional element such as a long short-term memory or Attention may be mounted to the third estimation model M3.

The third estimation model M3 is implemented by a combination of a program that causes the control device 11 to execute an arithmetic operation for generating a sound signal Z from the third input data D3, and a plurality of variables (specifically, weighted values and biases) to be applied to this arithmetic operation. The plurality of variables that define the third estimation model M3 are preset by machine learning and stored in the storage device 12.

A plurality of pieces of third training data are used for the machine learning of the third estimation model M3. Each piece of third training data includes the third input data D3 for the learning and a sound signal Z for the learning. The control data C specifies a musical piece, and the phoneme string data X specifies phoneme periods C5. The sound signal Z of each piece of third training data is the answer data that indicates the correct waveform of a voice singing the specified musical piece with the specified phoneme periods C5.

In the machine learning of the third estimation model M3, the plurality of variables of the third estimation model M3 are repeatedly updated such as to reduce the error between a sound signal Z the third estimation model M3 temporarily outputs in accordance with the third input data D3 of each piece of third training data, and the sound signal Z of this third training data. Therefore, the third estimation model M3 outputs a statistically reasonable sound signal Z in response to unknown third input data D3 based on a potential relationship between the third input data D3 and the sound signal Z in each of the plurality of pieces of third training data. Specifically, the sound signal Z indicates the waveform of a voice singing the target musical piece specified by the control data C with the phoneme periods C5 specified by the phoneme string data X. As mentioned above, the phoneme string data X is dependent on the selected style, and therefore the sound signal Z is indirectly dependent, via the phoneme string data X, on the selected style. Therefore, when the selected style is changed, the waveform specified by the sound signal Z changes, too.

As described above, according to the first embodiment, the sound signal Z is generated by the third estimation model M3 through processing of third input data D3 that includes the phoneme string data X and pitch data Y. Therefore, a sound signal Z that is statistically reasonable can be generated based on a relationship that exists between the third input data D3 and the sound signal Z in each of the plurality of pieces of third training data used for the machine learning.

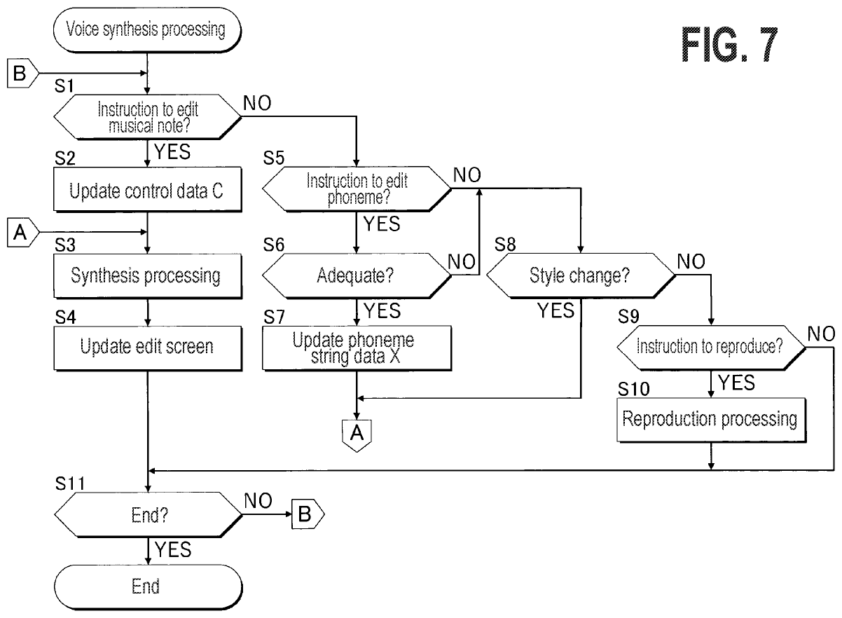

FIG. 7 is a flowchart of processing executed by the control device 11 of the sound processing system 100 (hereinafter referred to as “voice synthesis processing”). An instruction from a user input to the operation device 14 initiates the voice synthesis processing.

Once the voice synthesis processing is started, the control device 11 (score edit circuit 32) determines whether an instruction for editing a musical note has been received from the user (S1). The user instructs various editing tasks such as, for example, adding or deleting a musical note, or moving a musical note in the direction of time axis or pitch axis; extending or shortening a pronunciation period C2; and specifying or changing the pronounced letter C3 of a musical note. When there has been received an instruction to edit a musical note from the user (S1: YES), the control device 11 (score edit circuit 32) updates the control data C in accordance with the instruction from the user (S2).

The control device 11 (sound processing circuit 40) generates a sound signal Z by synthesis processing in which the updated control data C is applied (S3). The synthesis processing includes generation of phoneme string data X by the first generation circuit 41, generation of pitch data Y by the second generation circuit 42, and generation of a sound signal Z by the third generation circuit 43. The control device 11 (display control circuit 20) displays the results of synthesis processing on the display device 13 (S4). Specifically, the control device 11 displays a plurality of musical note images Ga corresponding to the control data C, and a pitch transition Gb corresponding to the pitch data Y in the edit region E1. When an operation is performed to the operation image E22, the control device 11 displays a plurality of end point images Gc corresponding to the phoneme string data X, and a signal waveform Gd corresponding to the sound signal Z in the edit region E1. After executing the above-described processing, the control device 11 proceeds the processing to step S11.

When there has not been received an instruction for editing a musical note (S1: NO), the control device 11 (characteristics edit circuit 33) determines whether an instruction to change an end point of a phoneme has been received from the user (S5). Specifically, the control device 11 determines whether an instruction to shift an end point image Gc has been received. When there has been received an instruction to change an end point of a phoneme (S5: YES), the control device 11 (characteristics edit circuit 33) determines whether the instruction from the user is adequate (S6). For example, the control device 11 determines that the instruction is adequate when the position of the end point shifted as instructed by the user is located within a predetermined range containing the end point before the shift, and not adequate if it is outside the range. When the instruction to shift an end point of a phoneme forward is an instruction to shift it more forward than an end point immediately before the end point to be shifted, the control device 11 determines that the instruction from the user is inadequate. Similarly, when the instruction to shift an end point of a phoneme backward is an instruction to shift it more backward than an end point immediately after the end point to be shifted, the control device 11 determines that the instruction from the user is inadequate. In other words, an instruction to shift an end point of a phoneme excessively is determined as inadequate.

When the instruction from the user is adequate (S6: YES), the control device 11 (characteristics edit circuit 33) updates the phoneme string data X in accordance with the instruction from the user (S7). The control device 11 (sound processing circuit 40) generates a sound signal Z by synthesis processing in which the updated phoneme string data X is applied (S3). The control device then displays the results of synthesis processing on the display device 13 (S4). In other words, a sound signal Z of the target sound, with the changes made to end points of phonemes being reflected, is generated. On the other hand, when the instruction from the user is inadequate (S6: NO), the control device 11 (characteristics edit circuit 33) proceeds the processing to step S8 without making alterations to edited portions P of the phoneme string data X. In other words, inadequate instructions from the user are invalidated and not reflected in the generation of the sound signal Z. This can reduce the possibility of inadequate phoneme string data X being generated. Optionally, when the instruction from the user is inadequate (S6: NO), the control device 11 (display control circuit 20) may display a message in the display device 13 alerting that the user's instruction is inadequate and will be invalidated.

When there has not been received an instruction to change an end point of a phoneme (S5: NO), or, when the instruction from the user is inadequate (S6: NO), the control device 11 (pronunciation style selection circuit 31) determines whether an instruction to change the pronunciation style has been received from the user (S8). When there has been received an instruction to change the pronunciation style (S8: YES), the control device 11 (sound processing circuit 40) generates a sound signal Z by synthesis processing in which the style data Q corresponding to the changed pronunciation style is applied (S3). The control device then displays the results of synthesis processing on the display device 13 (S4). A sound signal Z of the target sound corresponding to the changed pronunciation style is thus generated.

When there has not been an instruction to change the pronunciation style (S8: NO), the control device 11 determines whether an instruction to reproduce the target sound has been received from the user (S9). When an instruction to reproduce the target sound is received (S9: YES), the currently most recent sound signal Z is supplied to the sound emission device 15 so that the target sound is reproduced (S10). When reproduction of the target sound has been executed, or when there has not been received an instruction to reproduce the target sound from the user (S9: NO), the control device 11 proceeds the processing to step S11.

At step S11, the control device 11 determines whether an instruction to end the voice synthesis processing has been received from the user. When there has not been received an instruction to end the processing (S11: NO), the control device 11 proceeds the processing to step S1. In other words, the generation and reproduction of the sound signal Z in accordance with instructions from the user are repeated. When an instruction to end the processing is received (S11: YES), the control device 11 ends the voice synthesis processing.

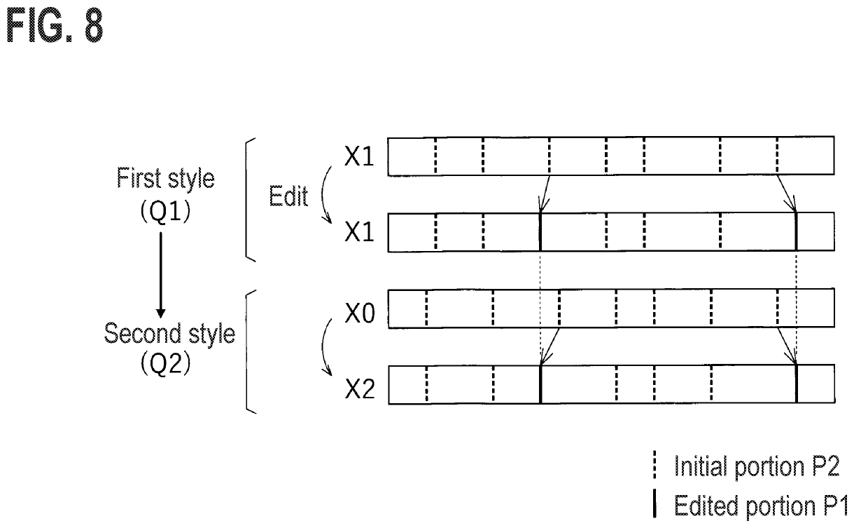

FIG. 8 illustrates how phoneme string data X is updated. FIG. 8 shows an example of phoneme string data X (hereinafter referred to as “first phoneme string data X1”) corresponding to a specific pronunciation style (hereinafter referred to as “first pronunciation style”). Namely, the first generation circuit 41 generates the first phoneme string data X1 by processing first input data D1 that includes control data C and style data Q indicating the first pronunciation style, using the first estimation model M1. The first phoneme string data X1 indicates an end point or end points P1 of one or more phonemes that have been shifted as instructed by the user (hereinafter referred to as “edited portion”). The control device 11 (characteristics edit circuit 33) updates the first phoneme string data X1, reflecting the shift in position of the edited portion P1 (S7).

Let us assume that the user has instructed to change the first pronunciation style to a second pronunciation style in this state (S8: YES). The second pronunciation style is a different pronunciation style from the first pronunciation style. The first pronunciation style and second pronunciation style are each a pronunciation style selected from a plurality of different pronunciation styles in accordance with an instruction from the user. The first generation circuit 41 generates phoneme string data X corresponding to the second pronunciation style (hereinafter referred to as “second phoneme string data X2”) by synthesis processing (S3) in which the style data Q2 of the second pronunciation style is applied.

As shown in the example in FIG. 8, when the second pronunciation style is specified, the first generation circuit 41 generates second phoneme string data X2 that indicates the positions of respective end points of a plurality of phonemes of the target sound. The plurality of end points indicated in the second phoneme string data X2 are classified into edited portions P1 and initial portions P2. In other words, the first generation circuit 41 generates second phoneme string data X2 that specifies the positions of edited portions P1 and initial portions P2. The initial portions P2 are some of the plurality of end points other than the edited portions P1.

The second phoneme string data X2 specifies the shifted position of each edited portion P1 in accordance with the instruction from the user given to the first phoneme string data X1. In other words, the editing made to the first phoneme string data X1 (i.e., shifting of end points of phonemes) is applied also to the second phoneme string data X2. Specifically, the edited portions P1 of the first phoneme string data X1 are used as they are for the edited portions P1 of the second phoneme string data X2, and the second pronunciation style is not reflected. On the other hand, the second phoneme string data X2 specifies the position of each initial portion P2 corresponding to the second pronunciation style. The edited portion P1 is an example of the “first portion”, and the initial portion P2 is an example of the “second portion”.

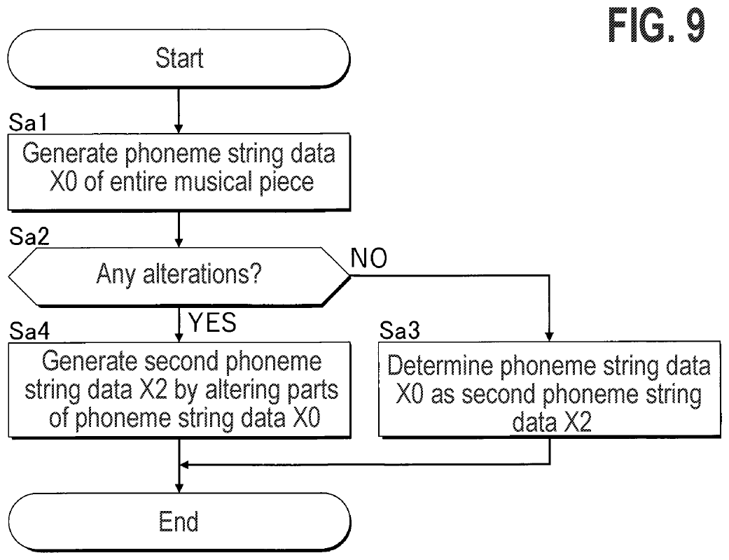

FIG. 9 is a flowchart of processing carried out by the first generation circuit 41 generating second phoneme string data X2. The processing in FIG. 9 is executed in the synthesis processing (S3) when the pronunciation style is changed (S8: YES).

First, the control device 11 (first generation circuit 41) generates initial phoneme string data X0 covering the entire target musical piece (Sa1) by processing first input data D1 that includes the control data C of the target musical piece, and the style data Q2 of the second pronunciation style, using the first estimation model M1. In other words, the second pronunciation style is reflected in the positions of end points of respective phonemes specified by the phoneme string data X0. On the other hand, the shifts in end points in accordance with instructions from the user given to the first phoneme string data X1 are not reflected in the phoneme string data X0.

The control device 11 (first generation circuit 41) determines whether the first phoneme string data X1 of the first pronunciation style (before it was changed) has been edited (Sa2). When the first phoneme string data X1 has not been edited (Sa2: NO), the control device 11 (first generation circuit 41) stores the phoneme string data X0 in the storage device 12 as second phoneme string data X2 (Sa3).

On the other hand, when the first phoneme string data X1 has been edited (Sa2: YES), the control device 11 (first generation circuit 41) generates second phoneme string data X2 (Sa4), in which the positions of respective edited portions P1 of a plurality of phonemes indicated in the phoneme string data X0 are changed to the same shifted positions of the edited portions P1 of the first phoneme string data X1. Meanwhile, the positions of respective initial portions P2 of the plurality of phonemes indicated in the phoneme string data X0 are maintained the same in the second phoneme string data X2. In other words, the first generation circuit 41 generates the initial portions P2 of the second phoneme string data X2 by processing the first input data D1 that includes the style data Q2 indicating the second pronunciation style, using the first estimation model M1. As is understood from the description above, when the second pronunciation style is specified, the first generation circuit 41 generates the second phoneme string data X2, which indicates the shifted positions of respective edited portions P1 in accordance with the instructions from the user, and which indicates the positions of respective initial portions P2 corresponding to the second pronunciation style.

As described above, according to the first embodiment, the second phoneme string data X2 is generated by changing the positions of some of the plurality of phonemes indicated in the phoneme string data X0 generated by the first estimation model M1 to the shifted positions of the edited portions P1. In other words, the processing itself of generating phoneme string data X using the first estimation model M1 is the same whether or not the end points of phonemes have been shifted (i.e., irrespective of the results of determination at step Sa2). Thus the processing for the generation of phoneme string data X can be simplified.

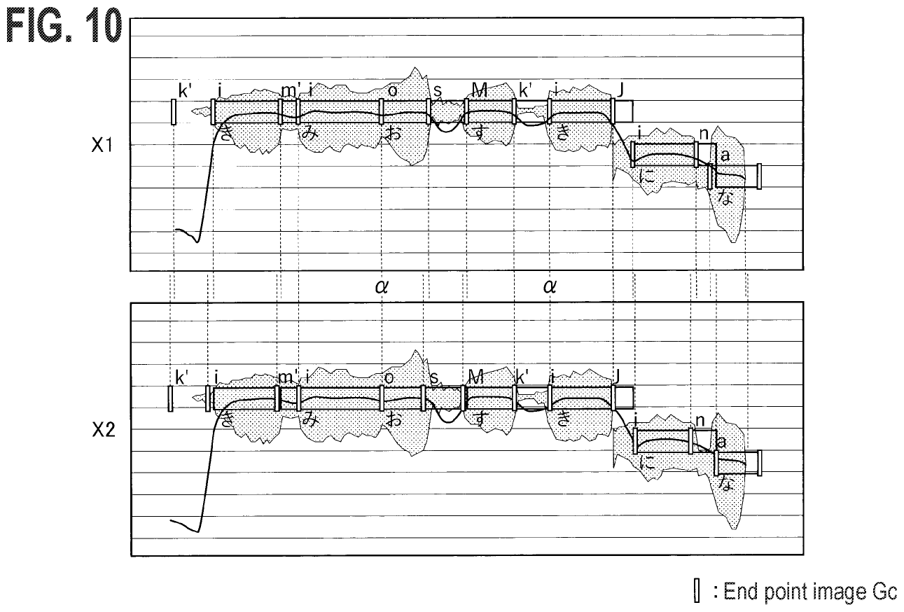

FIG. 10 shows specific examples of first phoneme string data X1 and second phoneme string data X2. FIG. 10 shows the edit regions E1 of both of the first phoneme string data X1 and second phoneme string data X2. Reference symbol a in FIG. 10 denotes the end points (end point images Gc) of respective phonemes that have been shifted in accordance with instructions from the user given to the first phoneme string data X1.

As is understood from FIG. 10, the positions of end points (edited portions P1) of respective phonemes that have been shifted in accordance with instructions from the user are the same in the first phoneme string data X1 and second phoneme string data X2. In other words, the end points where reference symbol a is added in FIG. 10 are the edited portions P1.

On the other hand, the end points of respective phonemes other than the edited portions P1 of the plurality of phonemes indicated in the first phoneme string data X1 are positioned in accordance with the first pronunciation style. The respective initial portions P2 of the plurality of phonemes indicated in the second phoneme string data X2 are positioned in accordance with the second pronunciation style. In other words, the end points of respective phonemes other than the edited portions P1 (initial portions P2) are set in the first phoneme string data X1 and second phoneme string data X2 independently from each other.

Specifically, the plurality of phonemes corresponding to the initial portions P2 may be located at different positions in the first phoneme string data X1 and second phoneme string data X2, or may be located at the same positions in the first phoneme string data X1 and second phoneme string data X2.

As described above, according to the first embodiment, first phoneme string data X1 corresponding to the first pronunciation style, and second phoneme string data X2 corresponding to the second pronunciation style, are generated. Therefore, a variety of target sounds with different pronunciation styles can be synthesized. The positions of the edited portions P1 that have been changed in accordance with instructions from the user given to the first phoneme string data X1 are maintained the same in the second phoneme string data X2. Therefore, the user need not give instructions again to change the positions of the edited portions P1 when changing the first pronunciation style to the second pronunciation style. Specifically, the positions of end points that have been changed in accordance with instructions from the user are maintained the same before and after the change in the pronunciation style. Therefore, there is no need for the user to make the same changes to the end points of specific phonemes every time the user changes pronunciation styles.

As described above, according to the first embodiment, a target sound that reflects instructions from the user can be generated, while the workload of the user in giving instructions is alleviated. For example, target sounds corresponding to a plurality of different pronunciation styles can be reproduced, with the changes made to the positions of phonemes in accordance with the instructions from the user being maintained. This allows the user to listen to and compare the target sounds in a plurality of pronunciation styles, with the positions of the phonemes being adjusted as desired by the user. In other words, the user's workload when comparing target sounds in a plurality of pronunciation styles can be alleviated.

According to the first embodiment, in particular, the end point positions of respective phonemes are indicated as a sound characteristic in the phoneme string data X. Therefore, a variety of target sounds, with the end point positions of phonemes varying depending on the pronunciation style, can be generated. For example, the starting point or ending point of each phoneme may vary largely, such as advanced or retarded, depending on the pronunciation style.

### Second Embodiment

The second embodiment will be described. It is to be noted that like reference numerals designate corresponding or identical elements throughout the above and following embodiments, and these elements will not be elaborated upon here.

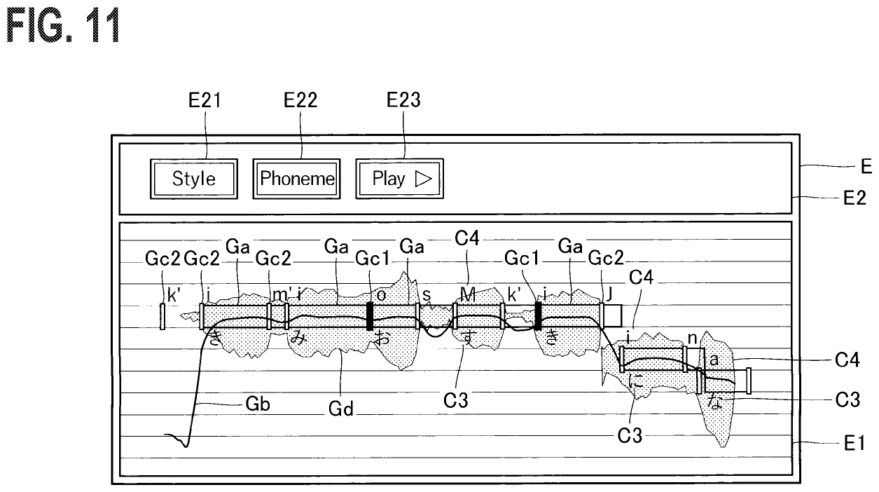

FIG. 11 is a schematic illustration of an edit screen E in the second embodiment. In the second embodiment, the plurality of end point images Gc displayed in the edit region E1 are classified into end point images Gc1 and end point images Gc2. The end point images Gc1 are some of the plurality of end point images Gc that correspond to edited portions P1. In other words, the end point images Gc1 correspond to the phonemes that have been shifted in accordance with instructions from the user, of a plurality of phonemes that make up the target sound. The end point images Gc2 are some of the plurality of end point images Gc that correspond to initial portions P2. In other words, the end point images Gc2 correspond to the phonemes that have not been shifted from initial positions, of a plurality of phonemes that make up the target sound.

The display control circuit 20 according to the second embodiment displays the end point images Gc1 and end point images Gc2 in different styles. Specifically, the end point images Gc1 and end point images Gc2 are displayed in different colors. In other words, the display control circuit 20 displays end point images Gc (Gc2) that have not been shifted from their initial positions in a first style. When an end point image Gc is shifted, the display style of this end point image Gc (Gc1) is changed from the first style to a second style.

The second embodiment provides advantageous effects similar to those provided in the first embodiment. According to the second embodiment, end point images Gc1 that have been shifted and end point images Gc2 that have not been shifted are displayed in different display styles. This provides the advantage of allowing the user to visually and intuitively know whether the end point of a phoneme has been shifted or not.

A display style of the end point images Gc here means image characteristics that are visually distinguishable for an observer. For example, the display color, pattern (design), size, or shape are included in the concept of the “display style”. The “display color” is defined by a color hue (tone), chroma, or lightness (tonal scale).

### Third Embodiment

According to the first embodiment, the editing target was phoneme string data X. The processing for changing pronunciation styles while maintaining edited portions P1 can be similarly applied to other time-series data than phoneme string data X. According to the third embodiment, the processing for changing pronunciation styles while maintaining edited portions P1 is applied to pitch data Y, which is one example of time-series data.

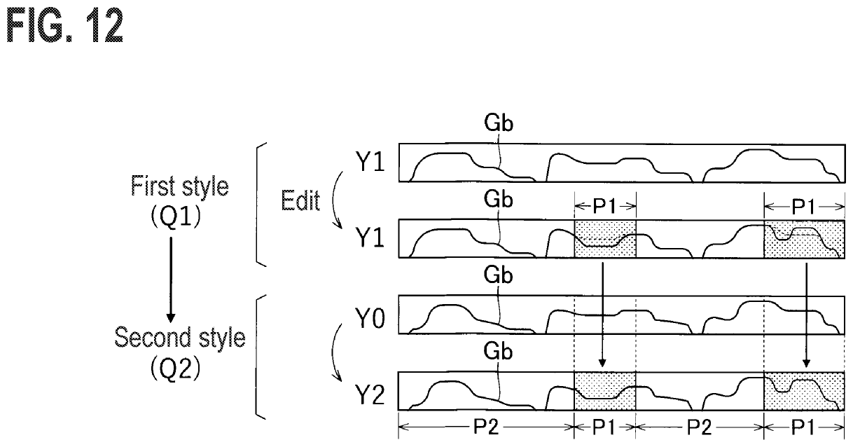

FIG. 12 illustrates how pitch data Y is updated in the third embodiment. FIG. 12 shows an example of first pitch data Y1 corresponding to a first pronunciation style. As described above, the second generation circuit 42 generates first pitch data Y1 by processing second input data D2 that includes control data C and phoneme string data X, using a second estimation model M2. The phoneme string data X is generated from the first input data D1 that includes the style data Q1 of the first pronunciation style. Therefore, the first pronunciation style is reflected in the phoneme string data X. As a result, the first pronunciation style is reflected also in the first pitch data Y1.

The user can instruct to change the pitch transition Gb indicated in the first pitch data Y1 by operating the operation device 14. Specifically, the user selects a desired portion of the pitch transition Gb indicated in the first pitch data Y1 as an edited portion P1, and instructs an alteration to be made in the edited portion P1 of the pitch time series. The characteristics edit circuit 33 updates the first pitch data Y1 so that the edited portion P1 indicates the pitch transition Gb after the alteration as instructed by the user. The pitch transition Gb is changed for one or more edited portions P1. As described above, according to the third embodiment, the edited portion P1 is a portion of the pitch transition Gb indicated in the first pitch data Y1 which the user instructed to be altered.

As the example in FIG. 12 shows, the second generation circuit 42 generates second pitch data Y2 corresponding to a second pronunciation style when an instruction is given to change the first pronunciation style to the second pronunciation style. The pitch transition Gb indicated in the second pitch data Y2 is divided into edited portions P1 and initial portions P2.

The second pitch data Y2 shows a pitch transition Gb with the alterations made to respective edited portions P1 of the first pitch data Y1 in accordance with the instructions from the user. In other words, the editing made to the first pitch data Y1 (i.e., changes made to the pitch transition Gb) is applied also to the second pitch data Y2. Specifically, the edited portions P1 of the first pitch data Y1 are used as they are for the edited portions P1 of the second pitch data Y2, and the second pronunciation style is not reflected there. On the other hand, the second pitch data Y2 shows the pitch transition Gb that corresponds to the second pronunciation style for respective initial positions P2.

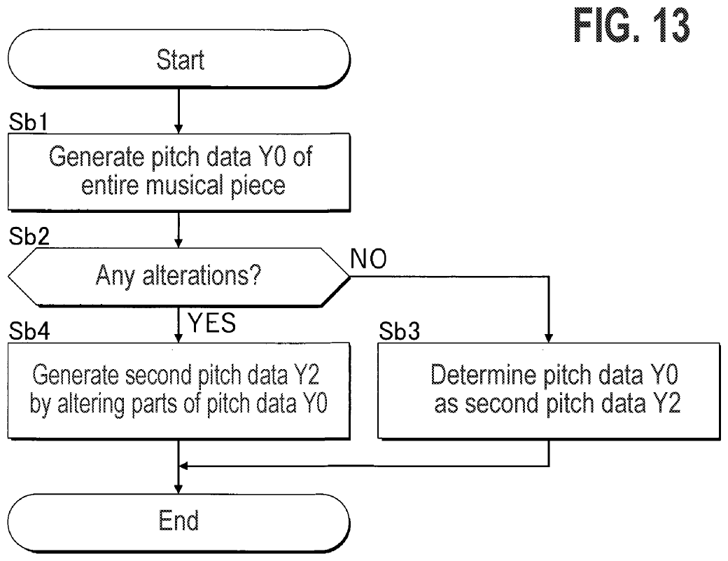

FIG. 13 is a flowchart of processing carried out by the second generation circuit 42 generating second pitch data Y2. The processing in FIG. 13 is executed in the synthesis processing (S3) when the pronunciation style is changed (S8: YES).

First, the control device 11 (second generation circuit 42) generates initial pitch data Y0 covering the entire target musical piece (Sb1) by processing second input data D2 that includes the control data C of the target musical piece, and the phoneme string data X generated by the first generation circuit 41, using the second estimation model M2. The phoneme string data X is generated from the first input data D1 that includes the style data Q2 of the second pronunciation style. Therefore, the second pronunciation style is reflected in the phoneme string data X. As a result, the second pronunciation style is reflected also in the pitch data Y0. The changes made to the pitch transition Gb of the first pitch data Y1 in accordance with instructions from the user are not reflected in the pitch data Y0.

The control device 11 (second generation circuit 42) determines whether the first pitch data Y1 of the first pronunciation style (before it was changed) has been edited (Sb2). When the first pitch data Y1 has not been edited (Sb2: NO), the control device 11 (second generation circuit 42) stores the pitch data Y0 in the storage device 12 as the second pitch data Y2 (Sb3).

On the other hand, when the first pitch data Y1 has been edited (Sb2: YES), the control device 11 (second generation circuit 42) generates second pitch data Y2 (Sb4) by changing the pitch transition Gb in the edited portions P1 of the pitch data Y0 to the pitch transition Gb in the edited portions P1 of the first pitch data Y1. Meanwhile, the pitch transition Gb in the initial portions P2 of the pitch data Y0 is maintained the same in the second pitch data Y2. As is understood from the description above, when the second pronunciation style is specified, the second generation circuit 42 generates the second pitch data Y2, which shows the pitch transition Gb after the changes were made to the edited portions P1 as instructed by the user, and which shows the pitch transition Gb corresponding to the second pronunciation style in the initial portions P2.

As described above, according to the third embodiment, the second pitch data Y2 is generated by changing the pitch transition Gb in some parts of the pitch data Y0 generated by the second estimation model M2 to the pitch transition Gb after the changes were made to the edited portions P1. In other words, the processing itself of generating pitch data Y using the second estimation model M2 is the same whether or not the pitch transition Gb has been changed. Thus the processing for the generation of pitch data Y can be simplified.

The third embodiment provides advantageous effects similar to those provided in the first embodiment. According to the third embodiment, in particular, the pitch transition Gb is indicated as a sound characteristic in the pitch data Y. Therefore, a variety of target sounds, with the pitch transition Gb varying depending on the pronunciation style, can be generated.

The configuration and operation examples for processing phoneme string data X shown in the first embodiment are similarly applicable to the processing of pitch data Y according to the third embodiment. For example, the control device 11 (second generation circuit 42) determines whether the instruction from the user to the first pitch data Y1 is adequate (S6). When the instruction is determined to be inadequate, no changes are made to the edited portions P1 of the first pitch data Y1.

### Fourth Embodiment

According to the first embodiment, the editing target was phoneme string data X. According to the third embodiment, the editing target was pitch data Y. According to the fourth embodiment, the processing for changing pronunciation styles while maintaining edited portions P1 is applied to a sound signal Z, which is one example of time-series data.

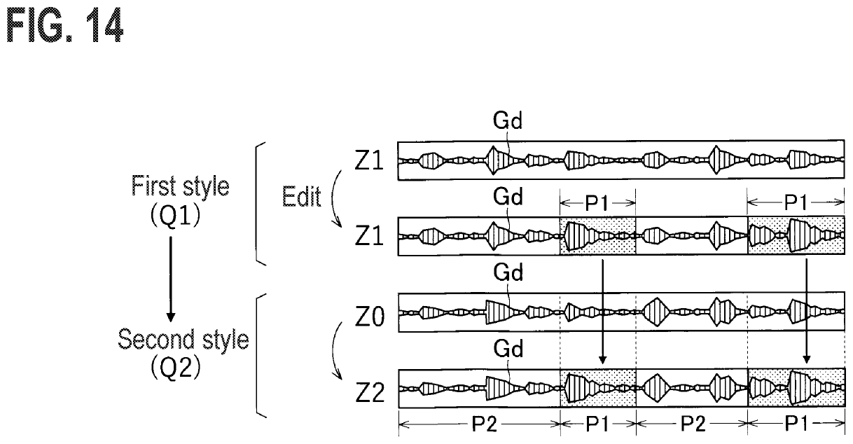

FIG. 14 illustrates how a sound signal Z is updated in the fourth embodiment. FIG. 14 shows an example of the first sound signal Z1 corresponding to a first pronunciation style. As described above, the third generation circuit 43 generates the first sound signal Z1 by processing the third input data D3 that includes the phoneme string data X and pitch data Y, using the third estimation model M3. Therefore, the first sound signal Z1 generated from the phoneme string data X and pitch data Y corresponding to the first pronunciation style reflects the first pronunciation style.

The user can instruct to make alterations to the first sound signal Z1 by operating the operation device 14. Specifically, the user selects a desired portion of the signal waveform Gd indicated in the first sound signal Z1 as an edited portion P1, and instructs a change in the waveform (amplitude and tone) in the edited portion P1. The characteristics edit circuit 33 updates the first sound signal Z1 so that the edited portion P1 shows the signal waveform Gd after the change as instructed by the user. The signal waveform Gd is changed for one or more edited portions P1. As described above, according to the fourth embodiment, the edited portion P1 is a portion of a signal waveform Gd indicated in the first sound signal Z1 which the user instructed to be altered.

As the example in FIG. 14 shows, the third generation circuit 43 generates a second sound signal Z2 corresponding to a second pronunciation style when an instruction is given to change the first pronunciation style to the second pronunciation style. The signal waveform Gd shown in the second sound signal Z2 is divided into edited portions P1 and initial portions P2 on the time axis.

The second sound signal Z2 shows a signal waveform Gd with the alterations made to respective edited portions P1 of the first sound signal Z1 in accordance with the instructions from the user. In other words, the editing made to the first sound signal Z1 (i.e., changes made to the signal waveform Gd) is applied also to the second sound signal Z2. Specifically, the edited portions P1 of the first sound signal Z1 are used as they are for the edited portions P1 of the second sound signal Z2, and the second pronunciation style is not reflected there. On the other hand, the second sound signal Z2 shows the signal waveform Gd corresponding to the second pronunciation style for respective initial portions P2.

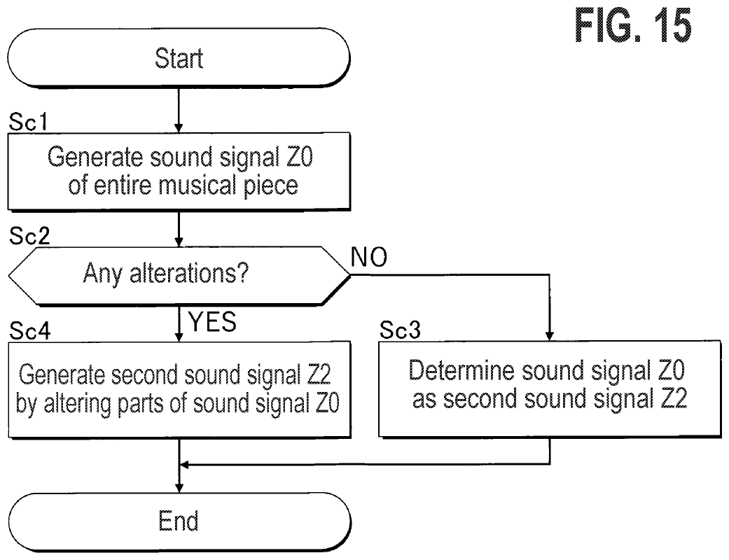

FIG. 15 is a flowchart of processing carried out by the third generation circuit 43 generating the second sound signal Z2. The processing in FIG. 15 is executed in the synthesis processing (S3) when the pronunciation style is changed (S8: YES).

First, the control device 11 (third generation circuit 43) generates an initial sound signal Z0 covering the entire target musical piece (Sc1) by processing third input data D3, using the third estimation model M3. The third input data D3 includes the phoneme string data X and pitch data Y of the second pronunciation style. Therefore, the second pronunciation style is reflected in the sound signal Z0. The changes made to the signal waveform Gd of the first sound signal Z1 in accordance with the instructions from the user are not reflected in the sound signal Z0.

The control device 11 (third generation circuit 43) determines whether the first sound signal Z1 of the first pronunciation style (before it was changed) has been edited (Sc2). When the first sound signal Z1 has not been edited (Sc2: NO), the control device 11 (third generation circuit 43) stores the sound signal Z0 in the storage device 12 as the second sound signal Z2 (Sc3).

On the other hand, when the first sound signal Z1 has been edited (Sc2: YES), the control device 11 (third generation circuit 43) generates a second sound signal Z2 (Sc4) by changing the signal waveform Gd in the edited portions P1 of the sound signal Z0 to the signal waveform Gd in the edited portions P1 of the first sound signal Z1. Meanwhile, the signal waveform Gd in the initial portions P2 of the sound signal Z0 is maintained the same in the second sound signal Z2. As is understood from the description above, when the second pronunciation style is specified, the third generation circuit 43 generates the second sound signal Z2, which shows the signal waveform Gd with the alterations made to respective edited portions P1 in accordance with the instructions from the user, and which shows the signal waveform Gd corresponding to the second pronunciation style for respective initial portions P2.

As described above, according to the fourth embodiment, the second sound signal Z2 is generated by changing the signal waveform Gd in some parts of the sound signal Z0 generated by the third estimation model M3 to the signal waveform Gd after the alteration to the edited portions P1. In other words, the processing itself of generating the sound signal Z using the third estimation model M3 is the same whether or not the signal waveform Gd has been changed. Thus the processing for the generation of sound signals Z can be simplified.

The fourth embodiment provides advantageous effects similar to those provided in the first embodiment. According to the fourth embodiment, in particular, the signal waveform Gd is indicated as a sound characteristic in the sound signal Z. Therefore, a variety of target sounds, with the signal waveform Gd varying depending on the pronunciation style, can be generated.

The configuration and operation examples for processing the phoneme string data X shown in the first embodiment are similarly applicable to the processing of the sound signal Z according to the fourth embodiment. For example, the control device 11 (third generation circuit 43) determines whether the instruction from the user to the first sound signal Z1 is adequate (S6). When the instruction is determined to be inadequate, no changes are made to the edited portions P1 of the first sound signal Z1.

As is understood from the examples shown through the first to fourth embodiments, the sound processing circuit 40 (first generation circuit 41, second generation circuit 42, or third generation circuit 43) can generally be described as an element that generates second time-series data (second phoneme string data X2, second pitch data Y2, or second sound signal Z2) when a second pronunciation style different from the first pronunciation style is specified. This second time-series data indicates a sound characteristic after the alteration to edited portions P1 as instructed by the user, and also indicates a sound characteristic of initial portions P2 other than the edited portions P1 corresponding to the second pronunciation style. The sound characteristic indicated by the phoneme string data X is the positions of end points of respective phonemes. The sound characteristic indicated by the pitch data Y is the pitch of the target sound. The sound characteristics indicated by the sound signal Z are the amplitude and tone of the target sound.

### Modifications

Modifications of the above-described embodiments will be described below. Any two or more modifications selected from the following may be combined as desired insofar as no contradiction occurs.

(1) In the embodiments described above, estimation models (first estimation model M1, second estimation model M2, or third estimation model M3) are used for generating time-series data. The method of generating a sound signal Z from control data C is not limited to the above-described examples. For example, the present disclosure is also applicable to concatenative voice synthesis in which a sound signal Z is generated by connecting a plurality of voice pieces.

For example, a plurality of voice libraries corresponding to different pronunciation styles are stored in the storage device 12. Each voice library is a database in which a plurality of voice pieces including single phonemes and sequences of phonemes are registered. The user selects a pronunciation style, and a sound signal Z of the target sound is generated using one of the plurality of voice libraries corresponding to the selected pronunciation style.

The sound processing circuit 40 (first generation circuit 41) selects voice pieces corresponding to pronounced letters C3 specified in time series by control data C from the voice library. The end point positions of respective phonemes making up the target sound are determined based on the durations or the like of the voice pieces registered in the voice library. Phoneme string data X indicating the end point positions of respective phonemes is thus generated. The sound processing circuit 40 (second generation circuit 42) generates pitch data Y in accordance with the control data C by a given known method. The sound processing circuit 40 (third generation circuit 43) adjusts the pitch of each voice piece in accordance with the pitch data Y, and couples together the adjusted voice pieces to generate a sound signal Z. In such concatenative voice synthesis, too, the processing similar to that in the above-described embodiments is applied to various pieces of time-series data (phoneme string data X, pitch data Y, and sound signal Z). As described above, the use of an estimation model may be omitted.

(2) In the examples shown in the above-described embodiments, the pronunciation style selection circuit 31 selects a pronunciation style in accordance with an instruction from the user. The method of selecting a pronunciation style is not limited to this example. For example, data that specifies chronological changes of pronunciation styles may be stored in the storage device 12, and the pronunciation style selection circuit 31 may select one pronunciation style after another in accordance with this data. Note, however, that the pronunciation style selection in accordance with an instruction from the user as described in the foregoing embodiments allows for generation of target sounds in pronunciation styles more in line with the user's intention.

(3) In the example shown in the above-described embodiments, the phoneme string data X indicates the positions of end points of respective phonemes. The sound units whose end points are specified by the phoneme string data X are not limited to single phonemes. Other examples of sound units include sequences of phonemes that are a plurality of phonemes coupled together, and syllables composed of one or more phonemes.

(4) In the above-described first embodiment, phoneme string data X0 covering the entire target musical piece is generated using the first estimation model M1 (Sa1) when generating the second phoneme string data X2. However, the step of generating the phoneme string data X0 may be omitted. For example, the first generation circuit 41 may generate initial portions P2 of the second phoneme string data X2 utilizing the control data C for the other portions than the edited portions P1 of the target musical piece, and add the edited portions P1 of the first phoneme string data X1 to these initial portions P2. The second phoneme string data X2 can be generated in this manner, too.

Similarly, the second generation circuit 42 may generate initial portions P2 of the second pitch data Y2 utilizing the control data C for the other portions than the edited portions P1 of the target musical piece, and add the edited portions P1 of the first pitch data Y1 to these initial portions P2. The second pitch data Y2 can be generated in this manner, too. Namely, the step of generating pitch data Y0 of the entire musical piece may be omitted. The third generation circuit 43 may generate initial portions P2 of the second sound signal Z2 utilizing the phoneme string data X and pitch data Y for the other portions than the edited portions P1 of the target musical piece, and add the edited portions P1 of the first sound signal Z1 to these initial portions P2. The second sound signal Z2 can be generated in this manner, too. Namely, the step of generating a sound signal Z0 of the entire musical piece may be omitted.

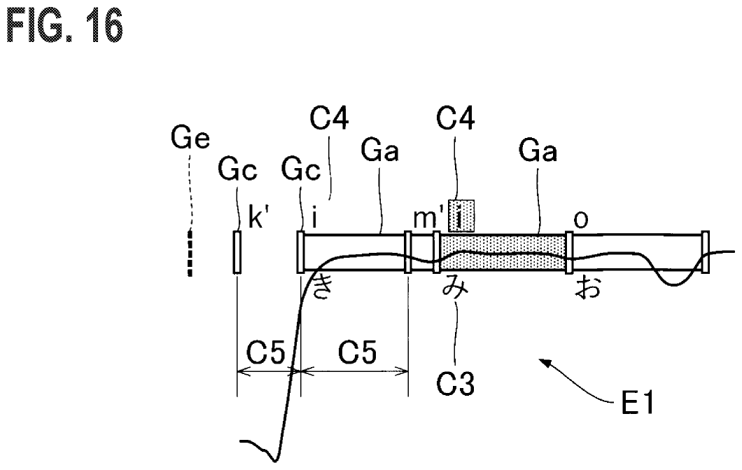

(5) In the above-described embodiments, an instruction from the user to shift an end point to outside of a predetermined range is invalidated (S6: NO). The display control circuit 20 may display the invalidated instruction from the user on the display device 13. For example, the display control circuit 20 displays an instruction image Ge at the position of the destination specified by the invalidated instruction, as shown in FIG. 16. Namely, the instruction image Ge is an image representing the point of time specified by an instruction from the user as the destination of an end point of a phoneme.

The display control circuit 20 displays the end point images Gc and instruction images Ge in different display styles. For example, the end point image Gc is a rectangular image, and the instruction image Ge is a dotted line image. The above-described embodiment allows the user to visually and intuitively know that their instruction to shift an end point was invalidated.

The configuration in which instruction images Ge are shown is applicable to any one of the first to fourth embodiments. In the second embodiment, end point images Gc1 and end point images Gc2 are displayed in different styles. In an embodiment where the feature of displaying the instruction images Ge is added to the second embodiment, the instruction images Ge are displayed in a style different from both of the end point images Gc1 and end point images Gc2.

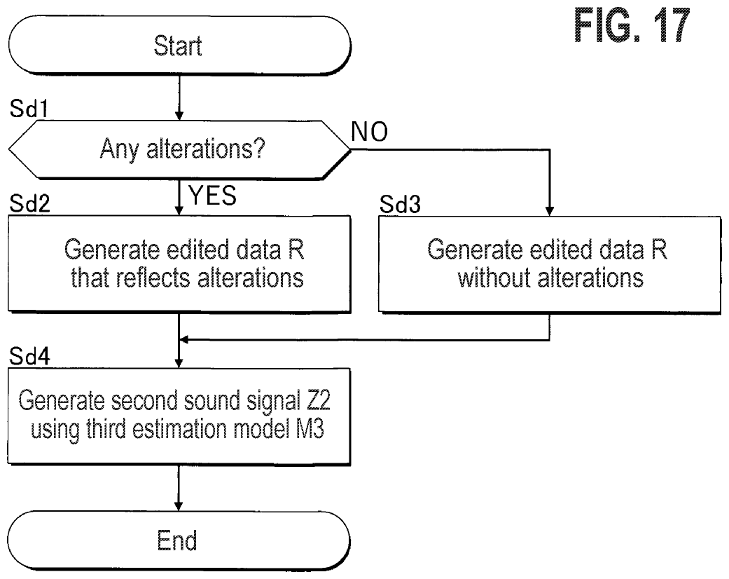

(6) In the fourth embodiment, the second sound signal Z2 is generated by changing parts of the sound signal Z0 generated using the third estimation model M3. The method of generating the second sound signal Z2 is not limited to the example described above. For example, the third generation circuit 43 may execute the processing shown in FIG. 17 instead of the processing shown in FIG. 15. The processing shown in FIG. 17 is executed in the synthesis processing (S3) when the pronunciation style is changed (S8: YES).

The control device 11 (third generation circuit 43) determines whether the first sound signal Z1 of the first pronunciation style (before it was changed) has been edited (Sd1). When the first sound signal Z1 has been edited (Sd1: YES), the control device 11 (third generation circuit 43) generates edited data R (Sd2) that indicates the contents of changes made to the first sound signal Z1.

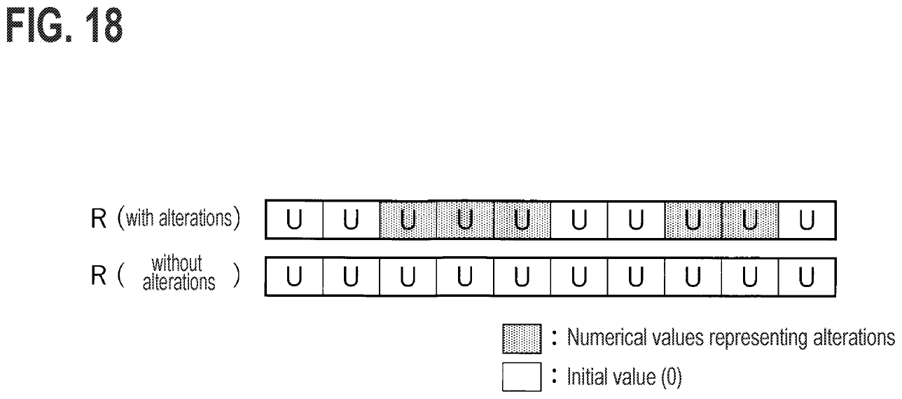

As shown in the example of FIG. 18, the edited data R is composed of a time series of a plurality of unit data pieces U, where each data piece corresponds to a different unit period on the time axis. The unit data piece U corresponding to each unit period indicates the content of change made to the waveform (amplitude and tone) as instructed for an edited portion P1 of the first sound signal Z1. For example, the unit data piece U of each unit period corresponding to an edited portion P1 of the first sound signal Z1 is set to a value that indicates the content of change. On the other hand, the unit data pieces U of other unit periods corresponding to other portions than the edited portion P1 of the first sound signal Z1 are set to an initial value (e.g., zero).

When the first sound signal Z1 has not been edited (Sd1: NO), the control device (third generation circuit 43) generates edited data R in which all the unit data pieces U are set to the initial value (Sd3) as illustrated in the example in FIG. 18. In other words, edited data R, which indicates that the first sound signal Z1 has not been edited, is generated.

After generating the edited data R in the above-described procedure, the control device 11 (third generation circuit 43) generates the second sound signal Z2 (Sd4) by processing third input data D3, using a third estimation model M3. The third input data D3 includes the edited data R in addition to the phoneme string data X and pitch data Y similar to those of the previously described embodiments. The third estimation model M3 is a statistical model that has learned the relationship between the third input data D3 that includes the edited data R and the sound signal Z by machine learning. Therefore, the second sound signal Z2 shows a signal waveform Gd after the changes were made to the edited portions P1 of the first sound signal Z1 in accordance with the instructions from the user. In other words, the editing made to the first sound signal Z1 is applied also to the second sound signal Z2.

As is understood from the description above, when the second pronunciation style is specified, the third generation circuit 43 generates the second sound signal Z2, similarly to the fourth embodiment. The second sound signal shows the signal waveform Gd with the alterations made to respective edited portions P1 in accordance with the instructions from the user, and shows the signal waveform Gd corresponding to the second pronunciation style for respective initial portions P2. The step of generating a sound signal Z0 of the entire musical piece is omitted.

In the embodiment described above, one example was shown in which edited data R is applied to the generation of the second sound signal Z2. The edited data R is similarly applicable to the generation of the second phoneme string data X2 (FIG. 9) in the first embodiment, and the generation of the second pitch data Y2 (FIG. 13) in the third embodiment.

For example, the first generation circuit 41 generates edited data R that indicates the contents of changes made to the first phoneme string data X1. When the second pronunciation style is specified, the first generation circuit 41 generates second phoneme string data X2 by processing the first input data D1 using the first estimation model M1. The first input data D1 includes the edited data R in addition to the control data C and style data Q. Namely, the first generation circuit 41 generates the second phoneme string data X2, which indicates the shifted positions of respective edited portions P1 in accordance with the instructions from the user, and which indicates the positions of respective initial portions P2 corresponding to the second pronunciation style. As is understood from the description above, the step of generating phoneme string data X0 of the entire musical piece (Sa1) may be omitted.

The second generation circuit 42 generates edited data R that indicates the contents of changes made to the first pitch data Y1. When the second pronunciation style is specified, the second generation circuit 42 generates second pitch data Y2 by processing the second input data D2 using the second estimation model M2. The second input data D2 includes the edited data R in addition to the control data C and phoneme string data X. Namely, the second generation circuit 42 generates the second pitch data Y2, which indicates the shifted positions of respective edited portions P1 in accordance with the instructions from the user, and which indicates the positions of respective initial portions P2 corresponding to the second pronunciation style. As is understood from the description above, the step of generating pitch data Y0 of the entire musical piece (Sb1) may be omitted.

(7) In the above-described embodiments, the example of the target sound was a singing sound of a target musical piece. The target sound is not limited to singing sounds. For example, the target sound to be generated may be an instrumental sound emitted when played with a musical instrument. In the embodiment where an instrumental sound is to be generated, the pronounced letters C3 are omitted from the control data C, and the first generation circuit 41 is omitted from the sound processing circuit 40. The second generation circuit 42 generates pitch data Y by inputting second input data D2 that includes control data C and style data Q to the second estimation model M2. Singing sounds and instrumental sounds are inclusively described as musical sounds that contain musical elements. A pronunciation style of a singing sound is also described as a “singing style”, and a pronunciation style of an instrumental sound is also described as a “performance style”. The present disclosure is also applicable to a case where a non-musical sound that does not require any musical elements is to be generated as the target sound. Non-musical sounds include speech sounds such as conversations, for example.

(8) The sound processing system 100 may be implemented by a server device that communicates with an information device such as a smartphone and tablet terminal. For example, the sound processing system 100 generates a sound signal Z using the control data C and style data Q that it received from an information device, and transmits the sound signal Z to the information device. Operation data indicative of the contents of operations made to the information device is transmitted from the information device to the sound processing system 100. The control device 11 (characteristics edit circuit 33) of the sound processing system 100 edits various pieces of time-series data (phoneme string data X, pitch data Y, sound signal Z) in accordance with the instructions from the user indicated in the operation data.

(9) As described above, the functions of the sound processing system 100 according to any of the above-described embodiments are implemented by cooperation of a single processor or a plurality of processors constituting the control device 11 with a program stored in the storage device 12. The program according to the present disclosure may be provided in the form of a computer-readable recording medium and installed in a computer. An example of the recording medium is a non-transitory recording medium, and a preferable example is an optical recording medium (optical disc) such as a CD-ROM. The recording medium, however, encompasses any other recording media, such as a semiconductor recording medium and a magnetic recording medium. As used herein, the term “non-transitory recording medium” is intended to mean any recording medium that is other than a transitory, propagating signal. A volatile recording medium is encompassed within the non-transitory recording medium. The program may be distributed from a distribution device via a communication network. In this case, a recording medium that stores the program in the distribution device corresponds to the non-transitory recording medium.

### Additional Notes

The above-described embodiments can be exemplified by the following configurations.

One form (form 1) of the present disclosure is a non-transitory computer-readable recording medium storing a program that, when executed by a computer system, causes the computer system to perform a method including altering a first portion of first time-series data in accordance with an instruction from a user, the first time-series data indicating a time series of a sound characteristic corresponding to a first pronunciation style of a target sound to be synthesized. The method also includes generating second time-series data when a second pronunciation style different from the first pronunciation style is specified for the target sound, the second time-series data indicating a sound characteristic with the alteration made to the first portion in accordance with the instruction from the user, and indicating a sound characteristic with a second portion other than the first portion corresponding to the second pronunciation style.

In this form, first time-series data corresponding to a first pronunciation style, and second time-series data corresponding to a second pronunciation style, are generated. Therefore, a variety of target sounds with different pronunciation styles can be synthesized. The sound characteristic in the first time-series data with the first portion altered in accordance with the instruction from the user is maintained in the second time-series data. Therefore, the user need not instruct the changes to the first portion again when changing the first pronunciation style to the second pronunciation style. In other words, the target sound that reflects instructions from the user can be generated, with reduced workload for the user in giving instructions.

The “target sound” is any sound to be synthesized. The “target sound” includes musical sounds containing musical elements (such as pitch and rhythm), and non-musical sounds that do not require any musical elements. Examples of musical sounds include singing sounds produced by a singer, for example, or instrumental sounds produced by a musical instrument. Examples of non-musical sounds include speech sounds such as conversations, for example.

The “(first/second) pronunciation style” refers to an acoustic nature of the target sound. Various natures of the target sound such as the tone or rhythm that affect the auditory impression are typical examples of the “pronunciation style”. In terms of singing, for example, a “pronunciation style” is exemplified by a peculiar way of singing such as ahead of the beat or behind the beat, or other expressive techniques. The “pronunciation style” is specified by various items that affect the pronunciation style such as the type of the sound source (e.g., singer), musical genre, language, and so on.

The “(first/second) time-series data” refers to any format of data that indicates a time series of a sound characteristic of the target sound. Examples of the sound characteristics include the pitch, volume, or tone of a sound. In the case with a singing sound, the positions of end points (starting points or ending points) of respective phonemes on the time axis are one example of sound characteristics. The sound characteristics include synthesizing conditions of the target sound (synthesis conditions).

The “first portion” refers to a time point or duration on the time axis that was edited in accordance with an instruction from the user. One or more first portions are set per first time-series data. The position or duration of a first portion on the time axis is set in accordance with an instruction from the user, for example. The “second portion” refers to a portion other than the first portion on the time axis. In other words, the “second portion” may be described as a portion not reflecting the instruction from the user.

In a specific example (form 2) of form 1, the target sound is a voice including a plurality of sound units on the time axis. The sound characteristic includes respective positions of end points of the plurality of sound units. The first portion is an end point whose position has been changed by the user, of a plurality of end points specified by the first time-series data. In the above-described form, the end point positions of respective sound units are indicated as a sound characteristic in the time-series data. Therefore, a variety of target sounds, with the end point positions of sound units varying depending on the pronunciation style, can be generated. For example, the start or end of sound emission of each sound unit may vary largely, such as advanced or retarded, depending on the pronunciation style. The end points that have been changed in accordance with instructions from the user are maintained the same before and after the change in the pronunciation style. Therefore, there is no need for the user to make the same changes to the end points of specific sound units every time the user changes pronunciation styles.

The “sound unit” refers to a phonetic unit of a voice. A typical example of the “sound unit” is a segmental unit based on phonemes such as vowels or consonants. Namely, a single phoneme may be considered a “sound unit”, and a sequence of a plurality of phonemes (phonetic sequence) may be considered a “sound unit”. A syllable composed of one or more phonemes is also included in the concept of “sound unit”.

In a specific example (form 3) of form 2, the first time-series data is generated by processing first input data using a first estimation model. The first input data includes control data specifying a synthesis condition of the target sound, and first style data indicating the first pronunciation style. The first estimation model is created by machine learning using a relationship between the first input data and time-series data in each of a plurality of pieces of training data. The sound processing also includes generating the second portion of the second time-series data by processing first input data using the first estimation model. The first input data includes the control data and second style data indicating the second pronunciation style. In the above-described form, (first/second) time-series data is generated by the first estimation model through processing of first input data that includes control data specifying a synthesis condition of a target sound, and (first/second) style data indicating a pronunciation style. Therefore, time-series data that is statistically reasonable can be generated based on a relationship that exists between the first input data and the time-series data in each of the plurality of pieces of first training data used for the machine learning.

In a specific example (form 4) of form 3, a portion of a sound characteristic in time-series data generated by the first estimation model to is changed with the alteration made to the first portion, to generate the second time-series data. In the above-described form, the second time-series data is generated by changing the first portion of the first time-series data generated by the first estimation model to the sound characteristic after it was changed in accordance with the instruction from the user. In other words, the processing itself of generating the time-series data using the first estimation model is the same whether or not the sound characteristic has been changed. Thus the processing for the generation of time-series data can be simplified.

In a specific example (form 5) of one of forms 2 to 4, second input data is processed using a second estimation model to generate pitch data indicating a time series of a pitch of the target sound. The second input data includes the control data and either the first time-series data or the second time-series data. The second estimation model is created by machine learning using a relationship between the second input data and pitch data in each of the plurality of pieces of the training data. The sound processing includes generating a sound signal that represents the target sound, using either the first time-series data or the second time-series data, and the generated pitch data. In the above-described form, pitch data is generated by the second estimation model through processing of second input data that includes control data specifying a synthesis condition of a target sound, and time-series data. Therefore, pitch data that is statistically reasonable can be generated based on a relationship that exists between the second input data and the pitch data in each of the plurality of pieces of training data used for the machine learning.

In a specific example (form 6) of one of forms 2 to 5, third input data is processed using a third estimation model to generate the sound signal. The third input data includes either the first time-series data or the second time-series data, and the generated pitch data. The third estimation model is created by machine learning using a relationship between the third input data and a sound signal in each of the plurality of pieces of the training data. In the above-described form, the sound signal is generated by the third estimation model through processing of third input data that includes time-series data and pitch data. Therefore, a sound signal that is statistically reasonable can be generated based on a relationship that exists between the third input data and the sound signal in each of the plurality of pieces of training data used for the machine learning.

In a specific example (form 7) of one of forms 1 to 6, the sound characteristic is a pitch of the target sound, and the first portion is a portion of a pitch time series indicated in the first time-series data, which the user instructed to be altered. In the above-described form, the pitch of the target sound is indicated as a sound characteristic in the time-series data. Therefore, a variety of target sounds, with the chronological pitch transition varying depending on the pronunciation style, can be generated.

In a specific example (form 8) of one of forms 1 to 7, the sound characteristic includes amplitude and tone of the target sound, and the first portion is a portion of a time series of amplitude and tone indicated in the first time-series data, which the user instructed to be altered. In the above-described form, the amplitude and tone of the target sound are indicated as sound characteristics in the time-series data. Therefore, a variety of target sounds, with the chronological transitions of amplitude and tone varying depending on the pronunciation style, can be generated.

In a specific example (form 9) of one of forms 1 to 8, the first pronunciation style and the second pronunciation style are each a pronunciation style selected from a plurality of different pronunciation styles in accordance with the instruction from the user. According to the above-described form, target sounds can be generated in pronunciation styles in line with the user's intention.

In a specific example (form 10) of one of forms 1 to 9, whether the instruction from the user is adequate is determined, and when the instruction is determined to be inadequate, the first portion is not altered. According to the above-described form, any inadequate instructions from the user are invalidated, so that the possibility of inadequate time-series data being generated can be reduced.

Another form (form 11) of the present disclosure is a computer system-implemented method of sound processing. The method includes altering a first portion of first time-series data in accordance with an instruction from a user. The first time-series data indicates a time series of a sound characteristic corresponding to a first pronunciation style of a target sound to be synthesized. The method also includes generating second time-series data when a second pronunciation style different from the first pronunciation style is specified for the target sound. The second time-series data indicates a sound characteristic with the alteration made to the first portion in accordance with the instruction from the user. The second time-series data also indicates a sound characteristic with a second portion other than the first portion corresponding to the second pronunciation style.

Another form (form 12) of the present disclosure is a sound processing system including: a sound processing circuit configured to generate time-series data indicating a time series of a sound characteristic of a target sound to be synthesized; and a characteristics edit circuit configured to change the time-series data in accordance with an instruction from a user. The sound processing circuit is configured to generate first time-series data indicating a time series of a sound characteristic of the target sound corresponding to a first pronunciation style. The characteristics edit circuit is configured to alter a first portion of the first time-series data in accordance with an instruction from the user. The sound processing circuit is configured to generate second time-series data when a second pronunciation style different from the first pronunciation style is specified for the target sound. The second time-series data indicates a sound characteristic with the alteration made to the first portion in accordance with the instruction from the user. The second time-series data also indicates a sound characteristic with a second portion other than the first portion corresponding to the second pronunciation style.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A non-transitory computer-readable recording medium storing a program that, when executed by a computer system, causes the computer system to perform a method comprising:
altering a first portion of first time-series data in accordance with an instruction from a user, the first time-series data indicating a time series of a sound characteristic corresponding to a first pronunciation style of a target sound to be synthesized; and
generating second time-series data when a second pronunciation style different from the first pronunciation style is specified for the target sound, the second time-series data indicating a sound characteristic with the alteration made to the first portion in accordance with the instruction from the user, and indicating a sound characteristic with a second portion other than the first portion corresponding to the second pronunciation style.

2. The non-transitory computer-readable recording medium according to claim 1,
wherein the target sound is a voice including a plurality of sound units on a time axis,
wherein the sound characteristic includes positions of respective end points of the plurality of sound units, and
wherein the first portion is an end point whose position has been changed by the user, of a plurality of end points specified by the first time-series data.

3. The non-transitory computer-readable recording medium according to claim 2,
wherein first input data is processed using a first estimation model to generate the first time-series data, the first input data including control data specifying a synthesis condition of the target sound, the first input data including first style data indicating the first pronunciation style, and wherein the first estimation model is created by machine learning using a relationship between the first input data and time-series data in each of a plurality of pieces of training data, and
wherein the first input data is processed using the first estimation model to generate the second portion of the second time-series data, the first input data including the control data and second style data indicating the second pronunciation style.

4. The non-transitory computer-readable recording medium according to claim 3, wherein a portion of a sound characteristic in time-series data generated by the first estimation model is changed with the alteration made to the first portion, to generate the second time-series data.

5. The non-transitory computer-readable recording medium according to claim 4, wherein second input data is processed using a second estimation model, the second input data including the control data and either the first time-series data or the second time-series data, and wherein the second estimation model is created by machine learning using a relationship between the second input data and pitch data in each of the plurality of pieces of the training data, to generate pitch data indicating a time series of a pitch of the target sound, and a sound signal representing the target sound is generated using either the first time-series data or the second time-series data, and the generated pitch data.

6. The non-transitory computer-readable recording medium according to claim 5, wherein third input data is processed using a third estimation model, the third input data including either the first time-series data or the second time-series data, and the generated pitch data, and wherein the third estimation model is created by machine learning using a relationship between the third input data and sound signal in each of the plurality of pieces of the training data, to generate the sound signal.

7. The non-transitory computer-readable recording medium according to claim 1, wherein the sound characteristic is a pitch of the target sound, and the first portion is a portion of a pitch time series indicated in the first time-series data, which the user instructed to be altered.

8. The non-transitory computer-readable recording medium according to claim 1, wherein the sound characteristic includes an amplitude and a tone of the target sound, and the first portion is a portion of a time series of amplitude and tone indicated in the first time-series data, which the user instructed to be altered.

9. The non-transitory computer-readable recording medium according to claim 1, wherein the first pronunciation style and the second pronunciation style are each a pronunciation style selected from a plurality of different pronunciation styles in accordance with the instruction from the user.

10. The non-transitory computer-readable recording medium according to claim 1, wherein whether the instruction from the user is adequate is determined, and when the instruction is determined to be inadequate, the first portion is not altered.

11. A computer system-implemented method of sound processing, the method comprising:
altering a first portion of first time-series data in accordance with an instruction from a user, the first time-series data indicating a time series of a sound characteristic corresponding to a first pronunciation style of a target sound to be synthesized; and
generating second time-series data when a second pronunciation style different from the first pronunciation style is specified for the target sound, the second time-series data indicating a sound characteristic with the alteration made to the first portion in accordance with the instruction from the user, and indicating a sound characteristic with a second portion other than the first portion corresponding to the second pronunciation style.

12. A sound processing system comprising:
a sound processing circuit configured to generate first time-series data indicating a time series of a sound characteristic corresponding to a first pronunciation style of a target sound to be synthesized;
a characteristics edit circuit configured to alter a first portion of the first time-series data in accordance with an instruction from the user; and
the sound processing circuit being further configured to generate second time-series data when a second pronunciation style different from the first pronunciation style is specified for the target sound, the second time-series data indicating a sound characteristic with the alteration made to the first portion in accordance with the instruction from the user, and indicating a sound characteristic with a second portion other than the first portion corresponding to the second pronunciation style.
